(19) United States
(12) Patent Application Publication
(10) Pub. No.: US 2006/0085813 A1
(43) Pub. Date: Apr. 20, 2006

(54) Real time location system and method

(75) Inventors: Timothy W. Giraldin, Ladera Ranch, CA (US); Patrick W. Giraldin, Ladera Ranch, CA (US); Regan E. Kelly, Laguna Niguel, CA (US)

Correspondence Address: DUCKOR SPRADLING METZGER, 401 WEST A STREET, SUITE 2400, SAN DIEGO, CA, 92101-7915, US

(73) Assignee: SafeTzone Technologies Corporation

(21) Appl. No.: 11/249,218

(22) Filed: Oct. 13, 2005

Related U.S. Application Data
(60) Provisional application No. 60/618,728, filed on Oct. 14, 2004.

(51) Int. Cl. H04N 7/16

(52) U.S. Cl. 725/25; 725/30

(57) ABSTRACT

A system and method is disclosed for tracking in real time the location of a person, animal, or other object in a community having a cable infrastructure. The system may include at least one identification tag, at least one stationary reader adapted to track the identification tag, and a controlling device adapted to receive information from the stationary reader and transmit information on the cable infrastructure. The method may include defining a plurality of zones within the community; locating a person, animal, or other object in the plurality of zones; determining a location of the person, animal, or other object; and providing the location of the person, animal, or other object on the cable infrastructure of the community.

### CROSS REFERENCES TO RELATED APPLICATIONS

This application is related in general to the following U.S. provisional and non-provisional applications:

This application claims priority to U.S. Provisional Patent Application Ser. No. 60/618,728, titled “REAL TIME LOCATION SYSTEM AND METHOD,” filed Oct. 14, 2004, which is incorporated herein by reference as if fully set forth herein.

The following U.S. patent applications are related to the present invention and are hereby incorporated by reference in their entirety: U.S. patent application Ser. No. 10/717,052, titled “QUEUE MANAGEMENT SYSTEM AND METHOD,” filed Nov. 18, 2003; U.S. patent application Ser. No. 10/716,800, titled “ROUTE PLANNING SYSTEM,” filed Nov. 18, 2003; U.S. patent application Ser. No. 10/716,583, titled “MESSAGE COMMUNICATION SYSTEM AND METHOD,” filed Nov. 18, 2003; U.S. patent application Ser. No. 10/716,802, titled “CASHLESS SPENDING SYSTEM AND METHOD,” filed Nov. 18, 2003; U.S. patent application Ser. No. 10/716,691, titled “DATA ANALYSIS SYSTEM AND METHOD,” filed Nov. 18, 2003; and U.S. patent application Ser. No. 09/992,668, filed Nov. 13, 2001, titled “SYSTEM FOR REAL-TIME LOCATION OF PEOPLE IN A FIXED ENVIRONMENT.”

The following U.S. patents are related to the present invention and are hereby incorporated by reference in their entirety: U.S. Pat. No. 6,424,264, titled “SYSTEM FOR REAL-TIME LOCATION OF PEOPLE IN A FIXED ENVIRONMENT,” filed Oct. 12, 2000, issued Jul. 23, 2002 and U.S. Pat. No. 6,747,562, titled “IDENTIFICATION TAG FOR REAL-TIME LOCATION OF PEOPLE,” filed Nov. 13, 2001, issued Jun. 8, 2004.

### FIELD OF THE INVENTION

The present invention relates in general to location systems and methods for communities or other large areas or environments, and it more specifically relates to tracking in real time the location of, for example, people, animals and objects within a community.

### Background Art

There is no admission that the background art disclosed in this section legally constitutes prior art.

In the past, neighborhood communities from time to time have suffered from the problem of losing track of people, animals or objects. To locate, for example, a missing child, individuals or groups of individuals would walk or drive around the neighborhood in an attempt to find the lost child. In some cases, assistance from local governmental authorities, such as the police department, may be summoned to assist in discovering the lost person, thereby increasing the cost of the search.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a real time location system in a community, which system is constructed in accordance with an embodiment of the invention; and

FIG. 2 is a pictorial view of a screen shot produced by the system of FIG.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the apparatus, systems, and methods of the present inventions, as represented in the drawings, is not intended to limit the scope of the invention, as claimed, but is merely representative of the embodiment of the invention.

A real time location system and method are disclosed for use in a community or other large defined areas or environments. According to one embodiment of the invention, at least one reader may be employed to track people, animals or other objects located in the area in question. The readers may supply real time location information to a computer via a suitable infrastructure or back bone such as a cable television infrastructure.

According to another embodiment of the present invention, a real time community locating system for a community having a cable infrastructure is disclosed. The system may include at least one identification tag, at least one stationary reader adapted to track the identification tag, and a controlling device adapted to receive information from the stationary reader and transmit information on the cable infrastructure.

According to still another embodiment of the present invention, a method of tracking people, animals, or objects in real time in a community having a cable infrastructure is disclosed. The method may include defining a plurality of zones within the community, locating a person, animal, or other object in the plurality of zones, determining or calculating a location of the person, animal, or other object, and providing the location of the person, animal, or other object on the cable infrastructure of the community.

A system and method as disclosed relate to tracking people, animals, and other objects in at least one zone in a community or other defined geographical area. At least one reader may be employed for reading identification tags placed on people, animals, and other objects typically moving through the community. The stationary reader may be operatively coupled to a cable television infrastructure or other back bone having a computer system incorporated therein. Software may operate on the computer system and receive location information from the stationary readers. The location information from the stationary readers may be transmitted via the cable television infrastructure or other back bone to the computer for processing. A user may then access this location information over any conventional means via the Internet or other network using computers.

A method and system as disclosed relate to tracking people, animals, and other objects in at least one zone in a neighborhood or defined geographical area. The method and system may include connecting a stationary reader to the neighborhood cable television infrastructure. The method and system may further include coupling a computer system to the cable television infrastructure and operating software on the computer system for receiving location information from the readers. The method and system may also include conveying the location information of the people, animals, and other objects over conventional means such as computers adapted to communicate over networks such as the Internet.

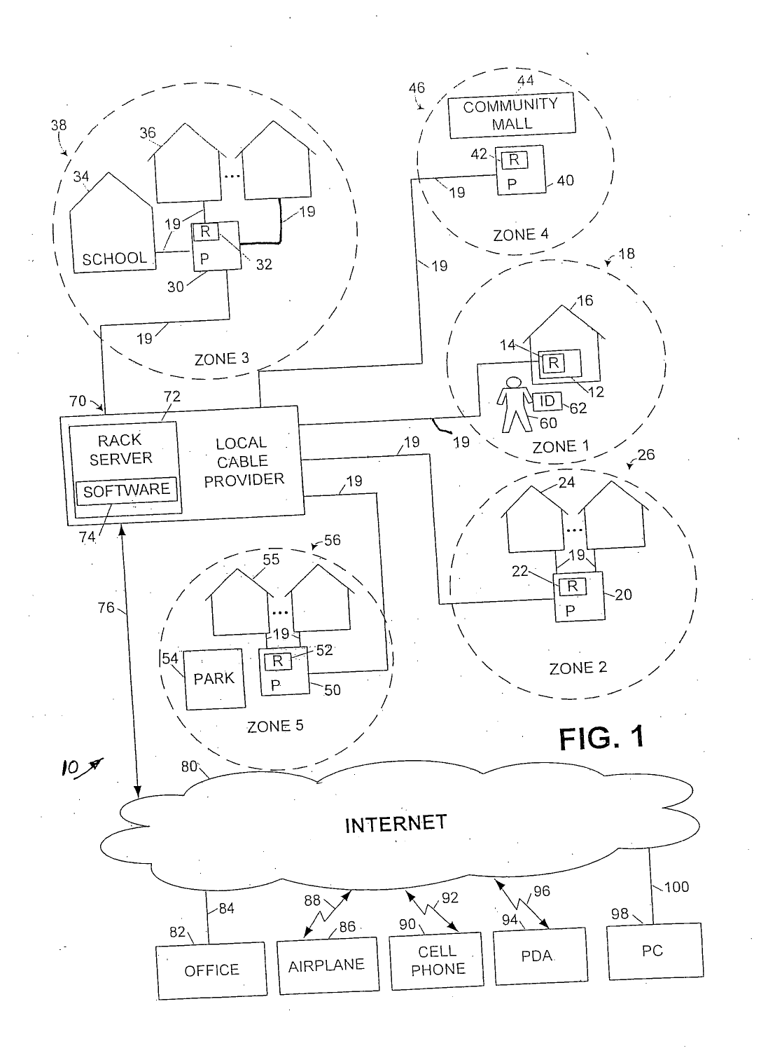

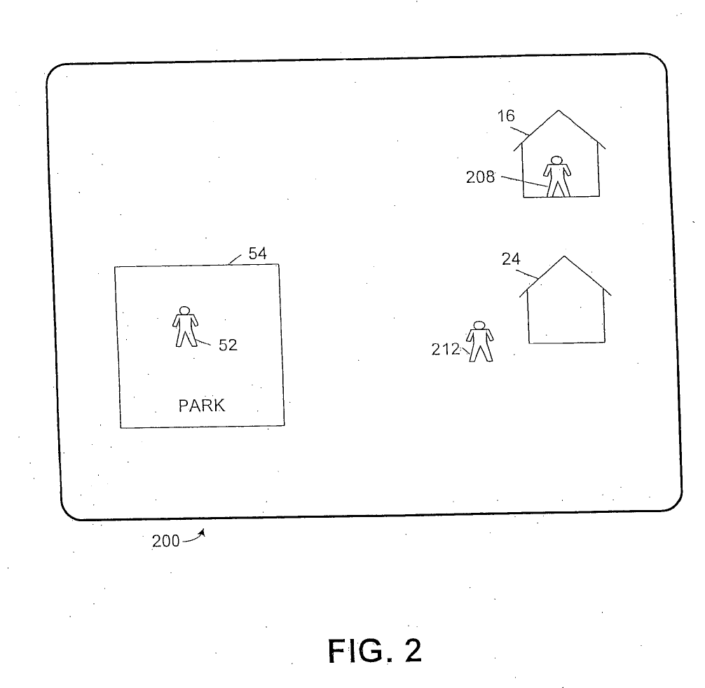

Referring now to FIGS. 1 and 2, there is shown a system 10 for tracking the real time location of people, animals, or other objects within a plurality of zones, such as zone 1 indicated at 18, that may be disposed about a community or other geographical area. Objects, such as a person 60, may be tracked positionally within the zone 18, or through other zones as the person travels through the community, using a conventional stationary reader, such as a reader 14, and an identification tag 62 such as a radio frequency identification tag attached to the object to be tracked, such as the person 60, to be tracked. The specific details about the stationary reader and the identification tag including their method and theory of operation may be found in one or more of the foregoing references.

Positional information about the identification tag 62 attached to or worn by the object to be tracked, such as the person 60, may be transmitted from the stationary reader 14 and other such readers distributed throughout the community via an infrastructure, such as a cable television system having cables 19 for communicating information to a local cable television provider 70. The local cable television provider may have a rack server 72 running software 74 that receives positional information from the stationary reader 14 and other such readers distributed throughout the community or other defined geographical area.

The positional information may then be accessed through any conventional means including personal and other computers using the Internet 80 or other networks. The information may be displayed on a display device such as a computer or television screen 200 (FIG. 2).

Considering now the zones in greater detail with reference to FIG. 1, each zone, such as the Zone 1 indicated at 18, may encompass a predefined geographical area, typically in a neighborhood or community where certain objects are desired to be tracked. Other zones may be dispersed in other geographical locations about the neighborhoods or other portions of the community such as Zone 2 through Zone 5, as indicated at 26, 38, 46, and 56 respectively. The zones may not be overlapping to help to uniquely define the location of the person, animal or other object being tracked.

Zones may be created where location information is desired to be tracked. For example, zone 1 as indicated at 18 may include a house 16 within the zone. The zone 1 could be used to define an area for tracing the location of people, such as the person 60, animals (not shown), or other objects (not shown) entering, leaving or traversing the zone.

A zone 2 indicated at 26 may contain a group of houses such as a house 24, one of which may include, for example, a handicapped person (not shown) such as a person afflicted with Alzheimer's or other maladies where it would be useful to detect the location of that person within that zone or other zones within the community in the case where the elderly person inadvertently wondered out of his or her home.

A zone 3 indicated at 38 may include a school 34 and a group of houses such as a house 36 where it may be desired to track the location of students (not shown) coming and going from the school 34.

A zone 4 indicated at 46 may include a community shopping mall 44 where it may be desired, for example, to track the location of objects such as store items (not shown) within the zone for theft protection. In addition the location of people (not shown), such as children (not shown), that inadvertently become separated from their parents (not shown) may be tracked.

A zone 5 indicated at 56 may contain a park 54 and a group of houses such as a house 55 where it may be desired to track the location of adults, children (not shown) playing in the park, animals such as pets and objects such as bicycles and skateboards.

Considering now the cable infrastructure in greater detail with reference to FIG. 1, the cable infrastructure provided may permit transmission of information other than traditional analog or digital television and computer signals. The cable infrastructure may permit the transmission of digital data, including Internet and TCP/IP data. The cables 19 may be routed to other zones throughout the neighborhood, community or other defined area.

The cable infrastructure may include a cable box, such as cable box 12 located in the house 16 within the zone 1, and a pedestal box, such as a pedestal box 20 within the zone 2 for routing cables 19 to the group of houses such as the house 24. The cable box may contain connection means to other portions of the cable infrastructure (not shown) for television sets (not shown), personal computers (not shown), or others such as telephones (not shown). The pedestal boxes may also be part of the cable infrastructure and may be generally strategically distributed throughout neighborhood or community areas to route cable signals such as television, computer, telephone and other signals to homes and to provide access to cable service personnel to install, monitor, or repair the cable infrastructure.

Cables 19 may connect a group of pedestal boxes and cable boxes that communicate with the local cable provider 70.

The pedestal and cable boxes may each be provided with a reader, thereby creating a zone around the box for tracking purposes. The distributed pedestal and cable boxes may be, in many instances, already installed in the community, and thus they may provide direct access to the cable infrastructure and a corresponding rack server 72.

Therefore, each zone, such as the zone 1 indicated at 18, may contain a portion of the cable infrastructure such as the cable box 12 which may provide access to the cable infrastructure. The stationary reader, such as a reader 14, may be electrically coupled to the cable box 12 for being connected in communication with the cable 19. Location information may be sent from the stationary reader 14 to the cable box and to the cable 19.

As a result, the reader 14 may be mounted within the house 16 and not within a pedestal box outside of the house. In this manner, the zone 1 associated with the reader 14 may include only a single house and nearby area, if desired.

In a similar manner, other zones such as zones 26, 38, 46 and 56, each may include a pedestal box having a reader such as readers 22, 32, 42, and 52, respectively. For example, the zone 2 indicated at 26 contains a stationary reader 22 electrically coupled to the cable infrastructure via a pedestal box 20. Other zones, such as zones indicated at 38, 42, and 53, also contain respective pedestal boxes 30, 40, and 50, each having a stationary reader such as readers 32, 42, and 52, respectively, electrically coupled to the cable infrastructure.

Considering now the local cable provider 70 in greater detail with reference to FIG. 1, the local cable provider 70 may contain a rack server 72 which operates software 74 adapted for receiving location data from stationary readers. The rack server 72 may be coupled to the cable 19 to connect the reader in communication with the rack server 72. Other computing and controlling devices could replace the rack server such as a programmable logic device, an ASIC, or a personal computer. The rack server 72 may also be coupled to the Internet 80. Thus, suitable software operating on the rack server 72 may communicate with the cable infrastructure, as well as the Internet 80.

In operation, the software 74 may operate on the rack server 72 and establish communications with the plurality of stationary readers, such as reader 14, via the rack server 72 and the cable infrastructure. The software may receive location information from the stationary readers to detect the location of identification tags, such as tag 62 carried by a person, to be tracked within the various zones within the community. The software may also receive the location information of objects detected within the zone 1 indicated at 18 over the cable infrastructure transmitted from the stationary readers attached thereto.

With continued reference to FIG. 1, real time location information about a person, animal or other object to be tracked may be provided over the Internet 80 to one or more locations such as an office 82, an airplane 86, a cell phone 90, a personal digital assistant (PDA) 94, and a personal computer (PC) 98. The office 82 and the PC 98 may receive the positional information from the Internet over any conventional communication means as shown by lines 84 and 100, respectively. The means may include a dial-up, a cable modem, a digital subscriber line (DSL), or a wireless connection. The airplane 86, the cell phone 90 and the PDA 94 may receive positional information over the Internet using conventional means as shown by lines 88, 92 and 96, respectively. These conventional communication means may include the Internet to be tracked over a conventional wireless connection such as a global system for mobile communications (GSM), a wireless local area network (LAN) in the 802.11 family, or a satellite.

According to other aspects of the disclosed embodiments of the present invention, the location of various persons, animals and objects being tracked may be displayed on the screen 200 (FIG. 2) of a computer such as the computer 98 or other suitable display device.

Considering now the screen in greater detail with reference to FIG. 2, the screen 200 is shown that provides a graphical display of the absolute and relative positions of people, animals, and objects that are being tracked by the stationary readers in the plurality of zones dispersed around the community. The screen 200 may provide a graphical view of one zone or multiple zones.

For example, the screen 200 may display positional information for the zone 5 indicated at 56 (FIG. 1). Stationary objects that are not being tracked such as streets, houses 16 and 24, or the park 54 may be shown as icons on the screen 200. The people, animals, and other objects being tracked, such as persons 52, 208, and 212 may be shown on the screen 200 as well.

In operation, as the people 52, 208, and 212 move within the zones, their absolute positions may be graphically displayed continuously in real time in relation to the geographical boundaries of the zones. Furthermore, their relative positions to other objects that are being tracked and non-tracked objects such as the house 16 are graphically displayed on the screen 200 as well.

The screen may not be limited to displaying positional information about a single zone. Multiple zones may be displayed simultaneously on the screen 200. Multiple zones, or portions thereof, with their relative positions to each other may be shown on the screen 200 as well.

The system 10 may provide location services and solutions. The system 10 may provide web-based location services accessible 24 hours per day, seven days per week, to authorized users. Delivery of location services may occur via multiple devices such as through a web-enabled device, a short message service (SMS) device, a cellular device, a television, a telephone, a PDA, or others. The system 10 also may supply or draw from a marketing/personal information database. The system 10 may also enable cashless spending capabilities.

The system 10 may provide a plurality of competitive advantages under some circumstances. The system 10 may provide location-based services which may leverage the pre-existing cable network infrastructure as well as the administrative, technical, and sales personnel of the cable provider. The system 10 may also enhance the position of the cable provider as an industry innovator and pioneer of emerging technologies.

Moreover, the system 10 may also provide enhanced satisfaction level of the existing cable provider's customer base and attract new customers to the cable provider. The system 10 may also provide additional revenue for the cable provider and help to retain customers. In addition, the cable provider's position as a community leader and benefactor may be strengthened and the cable provider may also experience a competitive edge over other competing telecommunication providers.

The system identification tag or locator such as the tag 62, may be provided in a number of different form factors and may be attached to or worn in a number of different ways including: as a pet collar, a key ring, as a shoe lace or shoe clips, as a bike reflector, as a skateboard, as a wheel chair, a wristwatch or others.

Providing location services may be important and provide many benefits such as customer attraction and retention for some applications. The system 10 may attract new customers by providing a unique service that may not available through competitors. That service or system 10 may be able to bring location services to communities to make the cable provider a partner in making their customers homes safer. In addition, additional sources of significant revenue may be realized by using an existing infrastructure, such as the infrastructure the cable provider owns, controls or leases. Another benefit of the system 10 may be the ability to strengthen the market position by adding additional services to existing customer base.

The system 10 may also provide web based location services. This may allow customers to have secure access to important information 24 hours per day, seven days per week, and enable customers to locate and track family members, pets, and other valuables within the community. The system 10 also may enable customers the ability to notify emergency services personnel with critical data.

The system 10 may employ readers in existing pedestal boxes and homes used by the cable provider, as well as readers installed in other locations such as telephone poles and others. Locators or tags may be provided to members of household to be used for family, pets, skateboards, bikes, etc. The cost for these devices may be added to their existing bill. The locators or tags communicate with the system readers thereby providing real-time location information to the system 10 database over an Ethernet connection. As a result, authorized users may access information at any time to find real-time location of family members, pets, assets, etc.

The result of installing the system 10 and selling services provided by the system 10 may allow the provider of the system 10 and the cable provider to help transform the communities into residents who are better able to communicate and thus to form lasting bonds. Important assets such as pets, bikes, skateboards and others may be easily monitored day and night. The determination of family members' locations may be only moments away.

Novel features may also be provided such as allowing family members to be notified if the family dog has left the yard. Parents may locate their children's toys such as a skateboard or bike if they forget to bring them home.

Importantly, all positional information may be kept personal and confidential and may not be released or viewed by anyone without permission.

The system 10 may provide a plurality of levels of service. For example, the customer may decide what level of service or peace of mind he/she desires. Such levels of service may include location only, alerts, or other levels of vigilance. Different levels of service may provide a peace of mind for the consumer.

In one embodiment, a customer may be alerted upon the system 10 locator or tag being read in certain zones. For example, an automatic text message may be made and sent to one's own receiving device such as a cellular phone, other wireless application protocol (WAP) enabled device or other, when one's child arrives home from school.

In another embodiment, geo-fencing may be provided. In this embodiment, a customer may set a personal perimeter for their family members or pets. For example, and automatic text message may be sent to one's cellular phone (or other WAP enabled device) if one's pet wanders more than two zones away from the yard. Geo-fencing can also be a great tool for families with special needs children.

This technology may be deployed by partnering with a cable provider in the community. Every cable customer may be a potential customer. Everyone inside the home may become a new cable customer.

The system 10 may be used in a plurality of different locations and applications such as community centers, homes, schools, malls and parks.

The system 10 may provide secure access to one's information through any web browser through an easy to use interface that permits updating and downloading of personal information. The ability to get to or send information worldwide in a short period of time such as a few seconds, may be provided through system 10.

The system 10 may enhance the cable provider's image and reputation within the community. The system 10 may provide peace of mind to families. The system 10 may provide additional product offerings with little or no large capital investment, and the system 10 provides the cable provider additional long term recurring revenue streams.

It will become apparent to those skilled in the art that the disclosed invention is subject to a variety of modifications without departing from the invention.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A real time community locating system for a community having a cable infrastructure, comprising
at least one identification tag;
at least one stationary reader adapted to track the identification tag; and
a controlling device adapted to receive information from the stationary reader and transmit information on the cable infrastructure.

2. The system of claim 1 wherein the stationary reader is electrically coupled to a cable box.

3. The system of claim 1, wherein the stationary reader is electrically coupled to a pedestal box.

4. The system of claim 1, wherein the controlling device is a rack server.

5. The system of claim 1, wherein the controlling device is a programmable logic device.

6. The system of claim 1, wherein the controlling device is an application-specific integrated circuit.

7. The system of claim 1, wherein the controlling device is a personal computer.

8. The system of claim 1, wherein the identification tag is attached to one of the group comprising a person, an animal, and an object.

9. The system of claim 1, further including a graphical display showing the location of the identification tag.

10. The system of claim 9, wherein the graphical display includes at least one stationary object.

11. A method of tracking people, animals, or objects in real time in a community having a cable infrastructure, comprising:
defining a plurality of zones within the community;
locating an object in the plurality of zones;
determining a location of the object; and
providing the location of the object on the cable infrastructure of the community.

12. The method of claim 11, wherein the object is a person.

13. The method of claim 11, wherein the object is an animal.

14. The method of claim 11, wherein one of the zones includes at least one house.

15. The method of claim 11, wherein one of the zones includes a school.

16. The method of claim 11, wherein one of the zones includes a park.

17. The method of claim 11, wherein one of the zones includes a community mall.

18. The method of claim 11, further including attaching an identification tag to the object.

19. The method of claim 11, further including placing a stationary reader in each of the zones.

20. The method of claim 19, further including connecting the stationary readers to the cable infrastructure.

21. The method of claim 11, wherein providing the location includes providing a graphical display of the location of the object in relation to geographic boundaries of a specific zone.

22. The method of claim 21, wherein the graphical display includes at least one stationary object.

23. The method of claim 21, wherein the graphical display includes at least two of the zones.

24. The method of claim 11, wherein providing the location includes transmitting the location onto the Internet.

25. The method of claim 11, wherein providing the location includes notifying a user when the object moves out of a particular zone.

26. The method of claim 11, wherein providing the location includes notifying a user when the object moves into a particular zone.
